(19) United States
(12) Patent Application Publication
(10) Pub. No.: US 2010/0209791 A1
(43) Pub. Date: Aug. 19, 2010

(54) FUEL CELL SYSTEM

(75) Inventors: Kota Manabe, Toyota-shi (JP); Shinji Aso, Toyota-shi (JP); Yoshiaki Naganuma, Nissin-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi-ken (JP)

(21) Appl. No.: 12/670,366

(22) PCT Filed: Jul. 23, 2008
(86) PCT No.: PCT/JP2008/063625

§ 371 Date: Jan. 22, 2010

(30) Foreign Application Priority Data
Jul. 30, 2007 (JP) 2007-197401

(51) Int. Cl. H01M 8/04

(52) U.S. Cl. 429/429

(57) ABSTRACT

Provided is a fuel cell system which can perform sufficient scavenging during a current system operation even if required sufficient scavenging during the previous system stop is not performed. When a control device detects that a system start command is input and a low temperature mode flag is turned “ON”, the control device compares a measured impedance during the previous system stop stored in a measured impedance memory to a low temperature start target impedance It stored in a reference impedance memory, to judge whether or not a scavenging process performed during the previous system stop has been insufficient. When the control device judges that the scavenging process is insufficient, an immediate warm-up operation is executed during the current system operation to immediately raise the temperature.

### TECHNICAL FIELD

The present invention relates to a fuel cell system.

### BACKGROUND ART

When an external temperature is low, problems occur, that is, water generated in a fuel cell system freezes after the stop of the system, and pipes, valves and the like break down, or the frozen water closes a gas passage and disturbs the supply of a gas at the next startup of a fuel cell, and an electro f chemical reaction does not sufficiently proceed.

In view of such problems, a technology is suggested in which a scavenging process is executed to decrease the amount of the water remaining in the fuel cell when a request for the stop of the system is made in an environment having a low outside air temperature, whereby the freezing of the pipes, valves and the like is prevented (e.g., see. Patent Document 1 described below).

[Patent Document 1] Japanese Patent Application Laid-Open No. 2005-108832

### DISCLOSURE OF THE INVENTION

Meanwhile, a system is stopped sometimes for a certain reason (e.g., the amount of a remaining fuel gas is small or the like), while any required sufficient scavenging process is not performed (in other words, while scavenging is insufficient).

In a case where an operation is stopped while the scavenging is insufficient in this manner and the operation is stopped immediately after the restart of the operation (e.g., a case where one goes to a nearby supermarket or the like), the scavenging process during the stop of the system is performed while a fuel cell is not sufficiently warmed up. Thus, in a case where the scavenging process is performed while the fuel cell is not sufficiently warmed up, the scavenging cannot sufficiently be performed, which causes a problem that power generation is not stabilized.

The present invention has been developed in view of the above situation, and an object thereof is to provide a fuel cell system capable of performing sufficient scavenging during a current system operation even when required sufficient scavenging is not performed during the previous system stop.

To achieve the above object, a fuel cell system of the present invention is a fuel cell system which performs a warm-up operation until a temperature concerned with a fuel cell reaches a reference temperature during a low temperature start, the system comprising: first judgment means for judging whether or not to perform the low temperature start during the start of the system; second judgment means for judging whether or not a scavenging process performed during the previous system stop has been insufficient; operation control means for continuing the warm-up operation until the temperature concerned with the fuel cell reaches a target temperature higher than the reference temperature in a case where the respective judgment means judge that the low temperature start is to be performed and that the scavenging process performed during the previous system stop has been insufficient; and scavenging means for performing the scavenging process during the system stop.

According to such a constitution, in a case where it is judged that the low temperature start is to be performed during the system start and it is judged that the scavenging process performed during the previous system stop has been insufficient, the warm-up operation is continued until the temperature concerned with the fuel cell reaches the target temperature (e.g., 70° C.) higher than the reference temperature (e.g., 0° C.). Therefore, even in a case where the operation is stopped for a short time, the sufficient scavenging process can be performed while the temperature of the fuel cell is raised to the target temperature. As well known, in a case where the scavenging process is performed while the temperature of the fuel cell is low, there occurs a problem that the sufficient scavenging cannot be performed or the like, but according to the above constitution, the scavenging process is performed while the temperature of the fuel cell is raised to the target temperature, and hence the sufficient scavenging can be performed in preparation for the next low temperature start.

Here, in the above constitution, a configuration is preferable in which the operation control means shifts to a normal operation after the end of the warm-up operation, and the warm-up operation is a low-efficiency operation having a large power loss as compared with the normal operation.

Moreover, in the above constitution, a configuration is further preferable in which the fuel cell system further comprises impedance measurement means for measuring the impedance of the fuel cell during the system stop, and the second judgment means judges whether or not the scavenging process has been insufficient, based on the impedance of the fuel cell measured during the previous system stop.

Furthermore, a configuration may be employed in which the fuel cell system further comprises scavenging means for performing the scavenging process during the system stop; and scavenging time measurement means for measuring a scavenging time during the system stop, and the second judgment means judges whether or not the scavenging process has been insufficient, based on the scavenging time measured during the previous system stop.

In addition, a configuration may be employed in which the fuel cell system further comprises estimation means for estimating the amount of water remaining in the fuel cell during the system stop, and the second judgment means judges whether or not the scavenging process has been insufficient, based on the amount of the water remaining in the fuel cell estimated during the previous system stop.

Moreover, in any one of the above constitutions, the temperature concerned with the fuel cell includes at least one of an outside air temperature, a component temperature around the fuel cell and a refrigerant temperature of the fuel cell, and the first judgment means judges whether or not to perform the low temperature start, based on the temperature concerned with the fuel cell.

As described above, according to the present invention, it is possible to perform the sufficient scavenging during the current system operation even when the required sufficient scavenging is not performed during the previous system stop.

### BRIEF DESCRIPTION OF THE DRAWINGS

FIG. 1 is a constitution diagram of a fuel cell system according to a first embodiment;

FIG. 2 is a flow chart showing a processing flow during a system stop according to the embodiment;

FIG. 3 is a flow chart showing a processing flow during a system start according to the embodiment;

FIG. 4 is a constitution diagram of a fuel cell system according to a second embodiment;

FIG. 5 is a flow chart showing a processing flow during a system stop according to the embodiment;

FIG. 6 is a constitution diagram of a fuel cell system according to a third embodiment; and

FIG. 7 is a flow chart showing a processing flow during a system stop according to the embodiment.

### BEST MODE FOR CARRYING OUT THE INVENTION

Hereinafter, a preferable embodiment of the present invention will be described with reference to the accompanying drawings. First, an outline of a fuel cell system of the present invention will be described.

### A. First Embodiment

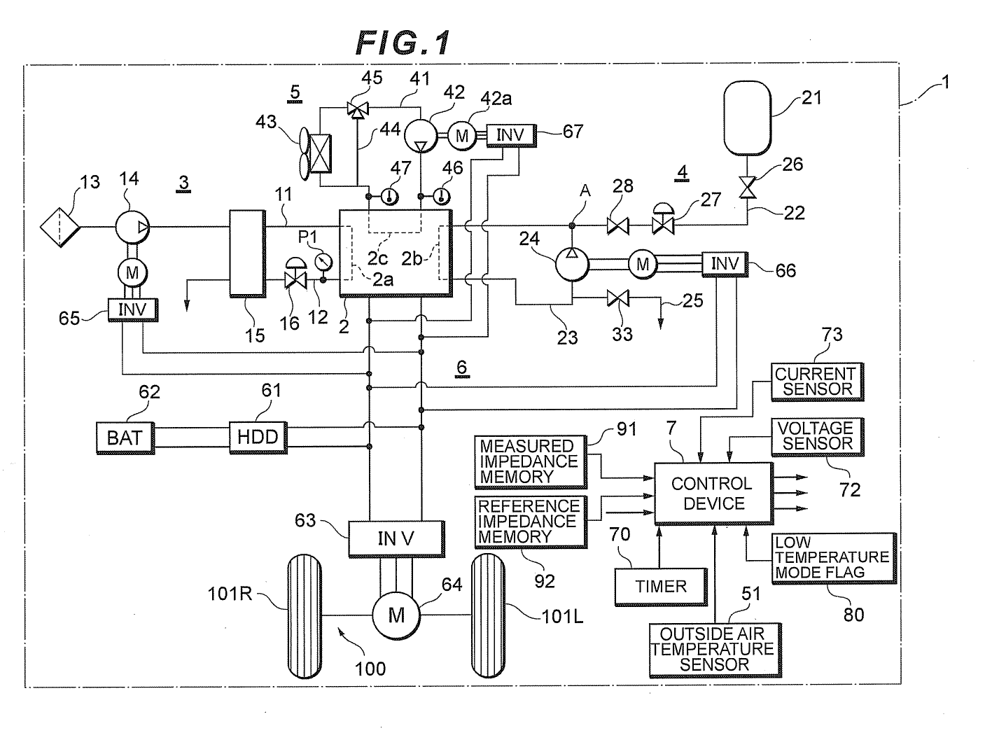

FIG. 1 is a constitution diagram of a fuel cell system 1 according to a first embodiment.

The fuel cell system 1 can be mounted in a vehicle 100 such as a fuel cell hybrid vehicle (FCHV), an electric car or a hybrid car. However, the fuel cell system 1 is applicable to various mobile bodies (e.g., a ship, an airplane, a robot, etc.) except the vehicle 100, a stational power source, and further a portable fuel cell system.

The fuel cell system 1 includes a fuel cell 2, an oxidizing gas piping system 3 which supplies air as an oxidizing gas to the fuel cell 2, a fuel gas piping system 4 which supplies a hydrogen gas as a fuel gas to the fuel cell 2, a refrigerant piping system 5 which supplies a refrigerant to the fuel cell 2, a power system 6 which charges or discharges the power of the system 1, and a control device 7 which integrally controls the operation of the system 1. The oxidizing gas and the fuel gas can generically be referred to as a reactant gas.

The fuel cell 2 is constituted of, for example, a solid polymer electrolyte type, and has a stack structure in which a large number of unitary cells are stacked. Each of the unitary cells has an air pole (a cathode) on one face of an electrolyte constituted of an ion exchange membrane, and a fuel pole (an anode) on the other face of the electrolyte, and further has a pair of separators which sandwich the air pole and the fuel pole between both sides. The oxidizing gas is supplied to an oxidizing gas passage 2a of one separator, and the fuel gas is supplied to a fuel gas passage 2b of the other separator. The fuel cell 2 generates a power by the electrochemical reaction of the supplied fuel gas and oxidizing gas. The electrochemical reaction in the fuel cell 2 is a heat generating reaction, and the fuel cell 2 of the solid polymer electrolyte type has a temperature of about 60 to 80° C.

The oxidizing gas piping system 3 has a supply path 11 through which the oxidizing gas to be supplied to the fuel cell 2 flows, and a discharge path 12 through which an oxidizing off gas discharged from the fuel cell 2 flows. The supply path 11 communicates with the discharge path 12 through the oxidizing gas passage 2a. The oxidizing off gas contains water generated by the cell reaction of the fuel cell 2, and hence has a highly wet state.

The supply path 11 is provided with a compressor 14 which takes outside air through an air cleaner 13, and a humidifier 15 which humidifies the oxidizing gas forwarded under pressure to the fuel cell 2 by the compressor 14. The humidifier 15 performs water exchange between the lowly wet oxidizing gas flowing through the supply path 11 and the highly wet oxidizing off gas flowing through the discharge path 12, and appropriately humidifies the oxidizing gas to be supplied to the fuel cell 2.

The back pressure of the fuel cell 2 on the side of the air pole is regulated by a back pressure regulation valve 16 disposed in the discharge path 12 near a cathode outlet. In the vicinity of the back pressure regulation valve 16, a pressure sensor P1 for detecting a pressure in the discharge path 12 is provided. The oxidizing off gas is finally discharged as an exhaust gas from the system to the atmosphere through the back pressure regulation valve 16 and the humidifier 15.

The fuel gas piping system 4 has a hydrogen supply source 21, a supply path 22 through which the hydrogen gas to be supplied from the hydrogen supply source 21 to the fuel cell 2 flows, a circulation path 23 which returns a hydrogen off gas (a fuel off gas) discharged from the fuel cell 2 to a joining part A of the supply path 22, a pump 24 which forwards the hydrogen off gas in the circulation path 23 under pressure to the supply path 22, and a purge path 25 branched and connected to the circulation path 23. The hydrogen gas discharged from the hydrogen supply source 21 to the supply path 22 by opening a main valve 26 is supplied to the fuel cell 2 through a pressure regulation valve 27, another pressure reduction valve and a block valve 28. The purge path 25 is provided with a purge valve 33 for discharging the hydrogen off gas to a hydrogen diluter (not shown).

The refrigerant piping system 5 has a refrigerant passage 41 which communicates with a cooling passage 2c in the fuel cell 2, a cooling pump 42 provided in the refrigerant passage 41, a radiator 43 which cools the refrigerant discharged from the fuel cell 2, a bypass passage 44 which bypasses the radiator 43, and a changeover valve 45 which sets the circulation of cooling water through the radiator 43 and the bypass passage 44. The refrigerant passage 41 has a temperature sensor 46 provided in the vicinity of a refrigerant inlet of the fuel cell 2, and a temperature sensor 47 provided in the vicinity of a refrigerant outlet of the fuel cell 2. A refrigerant temperature (a temperature concerned with the fuel cell) detected by the temperature sensor 47 reflects the internal temperature of the fuel cell 2 (hereinafter referred to as the temperature of the fuel cell 2). It is to be noted that the temperature sensor 47 may detect a component temperature around the fuel cell (the temperature concerned with the fuel cell) instead of (or in addition to) the refrigerant temperature. Moreover, the cooling pump 42 of the fuel cell is driven by a motor to circulate and supply the refrigerant in the refrigerant passage 41 to the fuel cell 2.

The power system 6 includes a high-pressure DC/DC converter 61, a battery 62, a traction inverter 63, a traction motor 64, and various auxiliary device inverters 65, 66 and 67. The high-pressure DC/DC converter 61 is a direct-current voltage converter, and has a function of regulating a direct-current voltage input from the battery 62 to output the voltage to a traction inverter 63 side, and a function of regulating a direct-current voltage input from the fuel cell 2 or the traction motor 64 to output the voltage to the battery 62. These functions of the high-pressure DC/DC converter 61 realize the charging/discharging of the battery 62. Moreover, the high-pressure DC/DC converter 61 controls the output voltage of the fuel cell 2.

The traction inverter 63 converts a direct current into a three-phase alternate current to supply the current to the traction motor 64. The traction motor 64 is, for example, a three-phase alternate-current motor. The traction motor 64 constitutes a main power source of, for example, the vehicle 100 in which the fuel cell system 1 is mounted, and is connected to wheels 101L, 101R of the vehicle 100. The auxiliary device inverters 65, 66 and 67 control the driving of motors for the compressor 14, the pump 24 and the cooling pump 42, respectively.

The control device 7 is constituted as a microcomputer including therein a CPU, an ROM and an RAM. The CPU executes desired calculation in accordance with a control program to perform various types of processing or control, for example, the control of a normal operation and the control of a warm-up operation described later. The ROM stores the control program or control data to be processed by the CPU. The RAM is used mainly as various operation regions for control processing.

A timer 70, a voltage sensor 72 and a current sensor 73 are connected to the control device 7. The timer 70 measures various types of time necessary for controlling the operation of the fuel cell system 1 (details will be described later). The voltage sensor 72 detects the output voltage (the FC voltage) of the fuel cell 2. Specifically, the voltage sensor 72 detects voltages (hereinafter referred to as “the cell voltage”) generated by a large number of unitary cells of the fuel cell 2, respectively. In consequence, the state of each unitary cell of the fuel cell 2 is grasped. The current sensor 73 detects the output current (the FC current) of the fuel cell 2.

The control device 7 inputs detection signals from various sensors such as the pressure sensor P1, the temperature sensors 46, 47, an outside air temperature sensor 51 which detects the outside air temperature (the temperature concerned with the fuel cell) of an environment where the fuel cell system 1 is disposed, an accelerator open degree sensor which detects the accelerator open degree of the vehicle 100 and the like, to output control signals to constituent elements (the compressor 14, the back pressure regulation valve 16, etc.). Moreover, when the system is started in a low temperature mode (hereinafter referred to as the low temperature start), the control device (second judgment means) 7 judges whether or not the scavenging process performed during the previous system stop has been insufficient to judge whether or not the amount of the water remaining in the fuel cell 2 needs to be decreased. Here, the control device (first judgment means) 7 judges whether or not to perform the low temperature start, based on the flag value of a low temperature mode flag 80. The flag value of the low temperature mode flag 80 is set to “ON” by the control device 7 when a start command in the low temperature mode is input by the button operation of a driver or the like, whereas the control device 7 sets the value to “OFF” when such an operation (including initialization) is not performed.

Here, it is judged whether or not the scavenging process performed during the previous system stop has been insufficient, based on the impedance of the fuel cell 2 measured during the previous system stop. This respect will be described in detail. First, the control device (impedance measurement means) 7 measures the impedance of the fuel cell 2 for each system stop. To measure the impedance of the fuel cell 2, the control device 7 samples, at a predetermined sampling rate, the voltage (the FC voltage) of the fuel cell 2 detected by the voltage sensor 72 and the current (the FC current) of the fuel cell 2 detected by the current sensor 73, to subject the same to Fourier transform processing (FFT calculation processing or DFT calculation processing) or the like. Then, the control device 7 measures the impedance of the fuel cell 2 by dividing an FC voltage signal subjected to the Fourier transform processing by an FC current signal subjected to the Fourier transform processing or the like.

The control device 7 stores the impedance (the measured impedance) of the fuel cell 2 measured in this manner in a measured impedance memory 91, to stop the system. Afterward, in a case where a system start command is input into the control device (the first judgment means) 7 by the ON operation of an ignition switch or the like and the control device detects that the low temperature mode flag 80 is turned “ON”, the control device reads a measured impedance Im during the previous system stop stored in the measured impedance memory 91, and reads a low temperature start target impedance It stored in a reference impedance memory 92, to compare both the impedances.

Here, the low temperature start target impedance It is a reference value for judging whether or not the amount of the water remaining in the fuel cell 2 during the start in the low temperature mode is adequate, and is obtained by an experiment or the like in advance. Specifically, the measured impedance for obtaining an optimum amount of the remaining water is obtained by the experiment or the like, and a map formed of this impedance is stored in the reference impedance memory 51. It is to be noted that the low temperature start target impedance It may be set to a fixed value, but the low temperature start target impedance may appropriately be changed in accordance with the temperature of the fuel cell 2 before the start or the like.

As a result of the comparison between both the impedances, the control device (the second judgment means) 7 judges that the scavenging process performed during the previous system stop is insufficient and that the amount of the water remaining in the fuel cell 2 needs to be decreased during a current system start. In this case, the control device (operation control means) 7 sets “Ready ON” when the temperature of the fuel cell 2 reaches a start reference temperature T1 (e.g., 0° C. or the like), and then the control device performs an immediate warm-up operation to immediately raise the temperature of the fuel cell 2 to a target temperature T2 (>T1; 70° C. or the like). Here, the immediate warm-up operation is an operation for allowing the self heat generation of the fuel cell 2, whereby the temperature of the fuel cell 2 can be raised for a short time as compared with the normal operation. Examples of such a warm-up operation include a low-efficiency operation for bringing the reactant gas into a slight shortage state to increase a power loss as compared with the normal operation, that is, a low-efficiency operation for decreasing the power generation efficiency of the fuel cell 2 to increase the amount of generated heat, and an operation for increasing the output current of the fuel cell 2 to increase the amount of the heat generated during the power generation. It is to be noted that the normal operation is an operation having a comparatively high power generation efficiency, and the low-efficiency operation can be considered as an operation having a comparatively low power generation efficiency. It is to be noted that in the present embodiment, the immediate warm-up operation will be described with respect to an example of the low-efficiency operation.

When the temperature is immediately raised to the target temperature T2 by the immediate warm-up operation, the control device 7 shifts to the normal operation. Afterward, when a system stop command is input by the OFF operation of the ignition switch or the like, the control device (scavenging means) 7 executes a necessary scavenging process to hold the amount of the water remaining in the fuel cell 2 at an adequate value in preparation for the next low temperature start.

To perform the low temperature start in this manner, it is judged whether or not the scavenging process performed during the previous system stop has been insufficient. In a case where it is judged that the scavenging process is insufficient, the immediate warm-up operation is executed during the current system operation to immediately raise the temperature. Thus, after starting the system operation, the immediate warm-up operation is performed immediately, whereby even in a case where the operation is stopped immediately after the restart of the operation (e.g., a case where one goes to a nearby supermarket; see the paragraphs of the problem to be solved by the invention), the fuel cell 2 has already been sufficiently warmed up, and hence sufficient scavenging can be realized. In consequence, during the next system start, the power generation can be started while the amount of the water remaining in the fuel cell 2 is kept at an adequate value. Hereinafter, the control during the operation stop and operation start of the fuel cell system 1 will be described.

### <Processing Flow During Operation Stop>

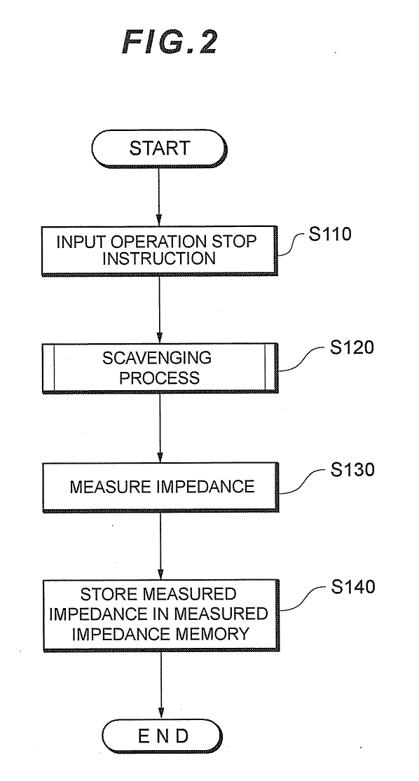

FIG. 2 is a flow chart showing a processing flow during the stop of the fuel cell system 1. It is to be noted that in the following description, there is assumed a case where the vehicle 100 runs in the low temperature mode (the temperature of the fuel cell 2 is less than a threshold temperature or the like).

When the OFF operation of the ignition switch or the like is performed by the driver of the vehicle 100 to input the operation stop instruction of the fuel cell system 1 (step S110), the scavenging process is performed in preparation for the next low temperature start (step S120).

Here, the scavenging process is a process for discharging the water from the fuel cell 2 to the outside at the end of the operation of the fuel cell 2 to scavenge the fuel cell 2. The scavenging process of a cathode system (the oxidizing gas piping system 3) is performed by supplying the oxidizing gas to the oxidizing gas passage 2a by the compressor 14 while the supply of the hydrogen gas to the fuel cell 2 is stopped and by discharging the water including formed water remaining in the oxidizing gas passage 2a to the discharge path 12 by this supplied oxidizing gas. It is to be noted that in addition to (instead of) this process, the scavenging process of an anode system (the fuel gas piping system 4) is performed, but the process can similarly be described, and hence the description is omitted herein.

At the end of the scavenging process, the control device 7 measures the impedance of the fuel cell 2 as described above (step S130). Then, the control device 7 stores the measured impedance obtained by the impedance measurement in the measured impedance memory 91, and then stops the system.

### <Processing Flow During Operation Start>

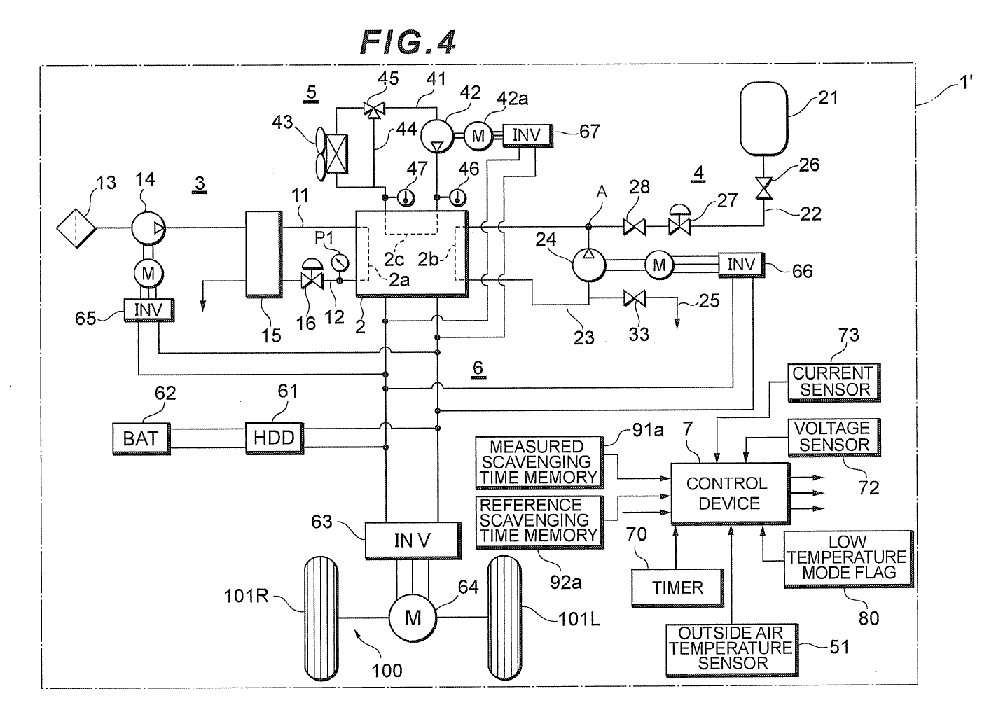

As shown in FIG. 4, when the operation start of the fuel cell system 1 is instructed by, for example, the ON operation of the ignition switch by the driver of the vehicle 100 or the like (step S210), the control device 7 judges whether or not to perform the low temperature start with reference to the low temperature mode flag 80 (step S220). As described above, the low temperature mode flag 80 is set to “ON” by the control device 7 when the start command in the low temperature mode is input by the button operation of the driver or the like, whereas the control device 7 sets the flag to “OFF” when such an operation (including initialization) is not performed.

In a case where the control device 7 judges that the low temperature start should not be performed (the step S220; NO), the control device advances to step S260 to start the normal operation. On the other hand, in a case where the control device 7 judges that the low temperature start should be performed (the step S220; YES), the control device grasps the amount of the water remaining in the fuel cell 2 during the previous system stop, and judges whether or not the scavenging process during the previous system stop has been insufficient (step S230). Specifically, as described above, the measured impedance Im during the previous system stop stored in the measured impedance memory 91 is compared to the low temperature start target impedance It stored in the reference impedance memory 92.

In a case where as a result of the comparison, the measured impedance Im is the low temperature start target impedance It or more and hence the control device 7 judges that the scavenging process during the previous system stop has been sufficient (the step S230; NO), the control device advances to the step S260 to start the normal operation. On the other hand, in a case where as a result of comparison, the measured impedance Im is below the low temperature start target impedance It and hence the control device 7 judges that the scavenging process during the previous system stop has been insufficient (the step S230; YES), after the temperature of the fuel cell 2 reaches the start reference temperature T1 (e.g., 0° C. or the like), the control device sets “Ready ON” and then starts the immediate warm-up operation to immediately raise the temperature of the fuel cell 2 to the target temperature T2 (>T1; 70° C. or the like) (step S240).

Afterward, the control device 7 judges whether or not the temperature rises to the target temperature T2 by the immediate warm-up operation (step S250). In a case where the control device 7 judges that the temperature does not rise to the target temperature T2, the control device returns to the step S240 to continue the immediate warm-up operation. On the other hand, in a case where the control device 7 judges that the temperature rises to the target temperature T2, the control device advances to the step S260 to perform the normal operation.

Afterward, the control device 7 judges whether or not the operation stop of the fuel cell system 1 has been instructed (step S270). When the operation stop of the fuel cell system 1 is not instructed, the control device 7 returns to the step S260 to continue the normal operation. On the other hand, in a case where the control device 7 detects that the operation stop of the fuel cell system 1 is instructed by the OFF operation of the ignition switch by the driver or the like (the step S270; YES), the control device performs the scavenging process to sufficiently decrease the amount of the water remaining in the fuel cell 2 in preparation for the next low temperature start (step S280), and then ends the processing.

As described above, according to the present embodiment, in a case where it is judged that the low temperature start should be performed during the system start and it is judged that the scavenging process performed during the previous system stop has been insufficient, the immediate warm-up operation is performed during the current system operation to immediately raise the temperature of the fuel cell 2 to the target temperature T2, and then the scavenging process is performed when the operation stop of the system is instructed. Therefore, even when the operation is stopped for the short time, the sufficient scavenging process can be performed while the temperature of the fuel cell 2 is raised to the target temperature T2. As well known, in a case where the scavenging process is performed while the temperature of the fuel cell 2 is low, there occurs a problem that the sufficient scavenging cannot be performed or the like. However, according to the above constitution, the scavenging process is performed while the temperature of the fuel cell 2 is raised to the target temperature T2, and hence the sufficient scavenging can be performed in preparation for the next low temperature start.

### B. Second Embodiment

In the above first embodiment, it is judged by using the measured impedance whether or not the scavenging process during the previous system stop has been insufficient, but it may be judged by using a scavenging time whether or not the scavenging process during the previous system stop has been insufficient. FIG. 4 is a diagram showing a constitution of a fuel cell system 1′ according to a second embodiment. It is to be noted that parts corresponding to those of FIG. 1 are denoted with the same reference numerals, and detailed description is omitted.

A measured scavenging time memory 91a is a memory which stores a time (a measured scavenging time) Tm of the scavenging process executed during the system stop, and a reference scavenging time memory 92a is a memory which stores an upper limit value (hereinafter referred to as a scavenging upper limit time) Tt of the scavenging time. The scavenging upper limit time Tt is a reference value for judging whether or not the amount of water remaining in a fuel cell 2 during a start in a low temperature mode is adequate, and the value is beforehand obtained by an experiment or the like in the same manner as in the low temperature start target impedance. It according to the embodiment.

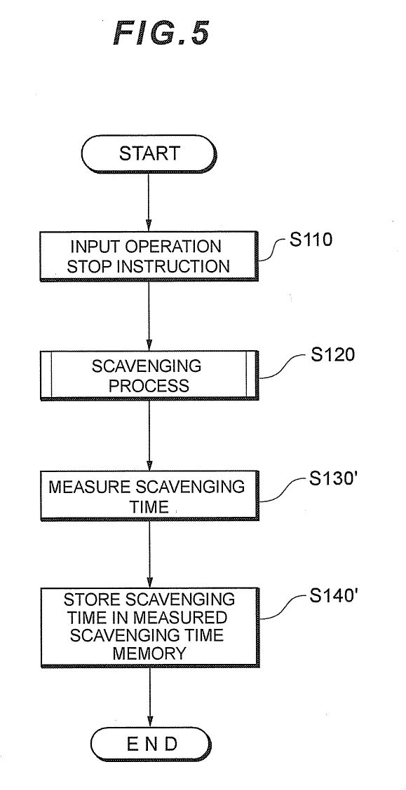

FIG. 5 is a flow chart showing a processing flow during the stop of the fuel cell system 1′ according to the second embodiment, and corresponds to the flow chart of FIG. 2 described above. It is to be noted that steps corresponding to those of FIG. 2 are denoted with the same reference numerals, and detailed description is omitted. Moreover, in the following description, there is assumed a case where a vehicle 100 runs in the low temperature mode (the temperature of the fuel cell 2 is less than a threshold temperature or the like) in the same manner as in the first embodiment.

When the OFF operation of an ignition switch or the like is performed by a driver of the vehicle 100 to input the operation stop instruction of the fuel cell system 1 (step S110), a scavenging process is performed in preparation for the next low temperature start (step S120).

Furthermore, a control device (scavenging time measurement means) 7 measures the time (the scavenging time) Tm from the start of the scavenging process to the end of the scavenging process by use of a timer 70 (step S130′), stores the measured scavenging time in the measured scavenging time memory 91a (step S140′), and then ends the processing.

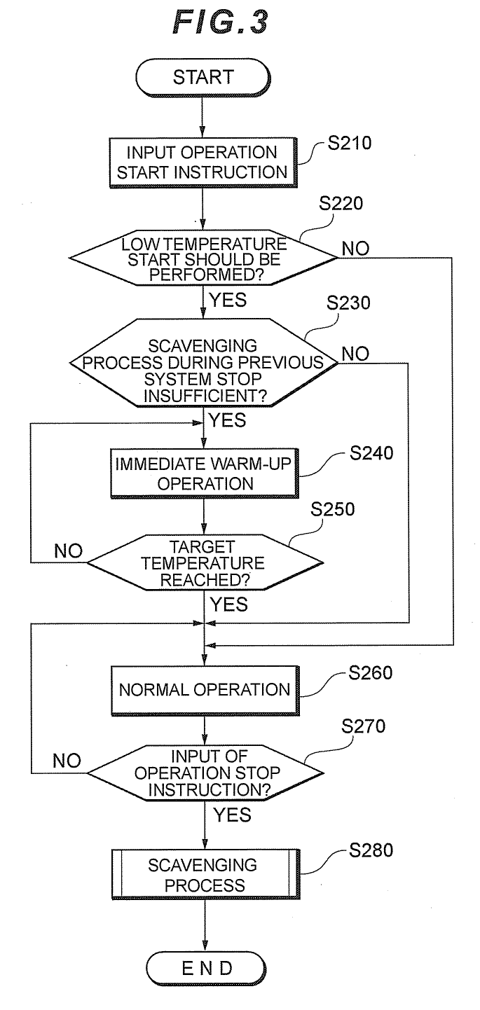

Afterward, as shown in FIG. 3, when the operation start of the fuel cell system 1 is instructed by, for example, the ON operation of the ignition switch by the driver of the vehicle 100 or the like (step S210), the control device 7 judges whether or not to perform a low temperature start with reference to a low temperature mode flag 80 (step S220). In a case where the control device 7 judges that the low temperature start should be performed (the step S220; YES), the control device grasps the amount of the water remaining in the fuel cell 2 during the previous system stop, and judges whether or not the scavenging process during the previous system stop has been insufficient (step S230). In the present embodiment, it is judged whether or not the scavenging process has been insufficient, based on the scavenging time during the previous system stop. This respect will be described in detail. The control device 7 compares the measured scavenging time Tm during the previous system stop stored in the measured scavenging time memory 91a to the scavenging upper limit time Tt stored in the reference scavenging time memory 92a. In a case where as a result of the comparison, the measured scavenging time Tm is the scavenging upper limit time Tt or more and hence the control device (second judgment means) 7 judges that the scavenging process during the previous system stop has been insufficient (the step S230; YES), the control device executes an immediate warm-up operation (step S240). It is to be noted that another operation can be described in the same manner as in the above embodiment, and hence further description is omitted.

Thus, it may be judged by using the scavenging time whether or not the scavenging process during the previous system stop has been insufficient. It is to be noted that it is judged by using a measured impedance whether or not the scavenging process during the previous system stop has been insufficient (the first embodiment), it is judged by using the scavenging time whether or not the scavenging process during the previous system stop has been insufficient (the second embodiment), and it may be judged whether or not to execute an immediate warm-up operation, based on both judgment results (e.g., OR or AND conditions).

### C. Third Embodiment

In the second embodiment, it is judged by using the scavenging time whether or not the scavenging process during the previous system stop has been insufficient, but it may be judged by using an estimated remaining water value whether or not the scavenging process during the previous system stop has been insufficient.

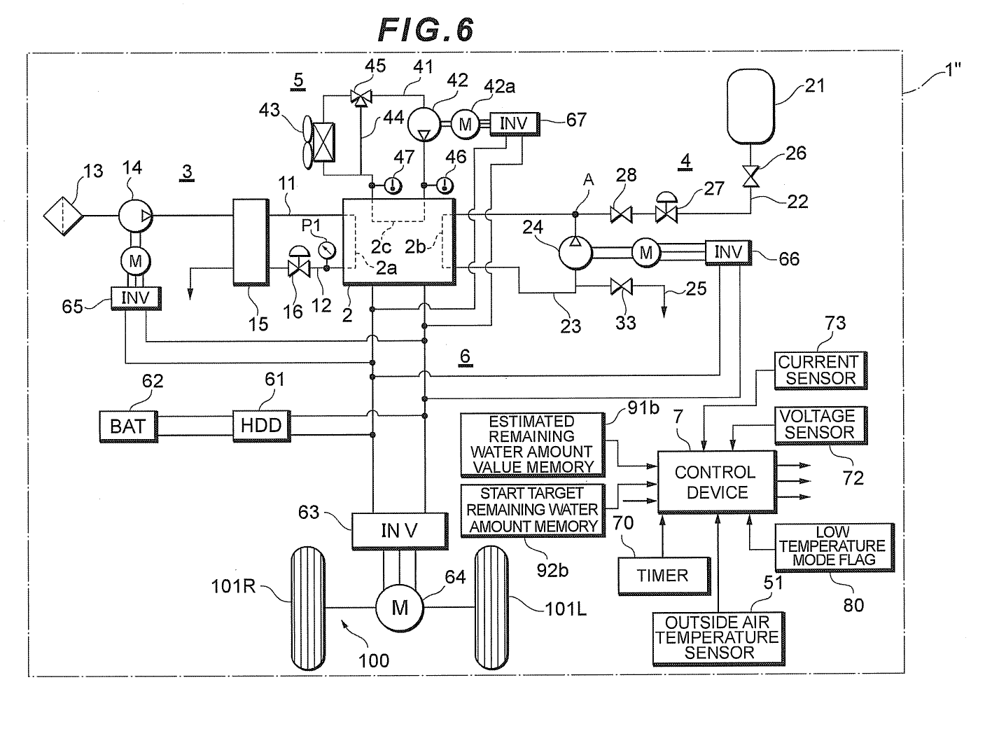

FIG. 6 is a diagram showing a constitution of a fuel cell system 1″ according to a third embodiment. It is to be noted that parts corresponding to those of FIG. 4 are denoted with the same reference numerals, and detailed description is omitted.

An estimated remaining water amount value memory 91b is a memory which stores the estimated value (hereinafter referred to as the estimated remaining water amount value) We of the amount of water remaining in a fuel cell 2 during the system stop, and a start target remaining water amount memory 92b is a memory which stores a remaining water amount (hereinafter referred to as the start target remaining water amount) Wt as a target during a system start. The start target remaining water amount Wt is a reference value for judging whether or not the amount of the water remaining in the fuel cell 2 during the start in a low temperature mode is adequate, and the value is beforehand obtained by an experiment or the like in the same manner as in the scavenging upper limit time Tt according to the second embodiment.

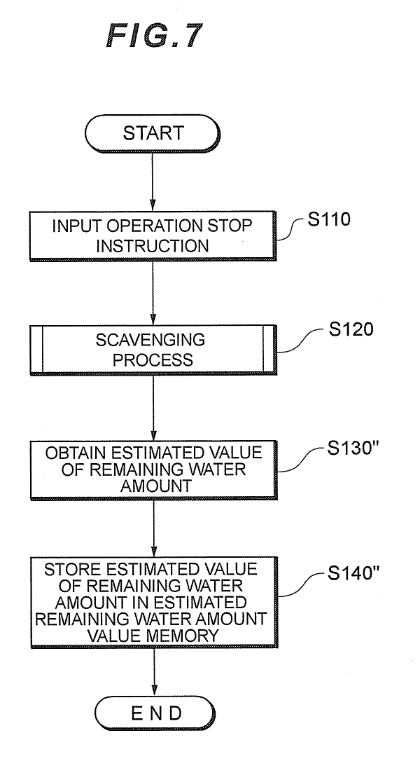

FIG. 7 is a flow chart showing a processing flow during the stop of the fuel cell system 1″ according to the third embodiment, and corresponds to the flow chart of FIG. 5 described above. It is to be noted that steps corresponding to those of FIG. 5 are denoted with the same reference numerals, and detailed description is omitted. Moreover, in the following description, there is assumed a case where a vehicle 100 runs in the low temperature mode (the temperature of the fuel cell 2 is less than a threshold temperature or the like) in the same manner as in the second embodiment.

When the OFF operation of an ignition switch or the like is performed by a driver of the vehicle 100 to input the operation stop instruction of the fuel cell system 1 (step S110), a scavenging process is performed in preparation for the next low temperature start (step S120).

Furthermore, a control device (estimation means) 7 obtains the estimated remaining water amount value We by use of the supply amount of an oxidizing gas to be supplied to the fuel cell 2 by a compressor 14, the amount (the formed water amount) of water formed during the power generation of the fuel cell 2, the integrated value of the amount of humidified external water or the like (step S130″), stores the obtained estimated remaining water amount value We in the estimated remaining water amount value memory 70b (step S140″), and then ends the processing.

Afterward, as shown in FIG. 4, when the operation start of the fuel cell system 1 is instructed by, for example, the ON operation of the ignition switch by the driver of the vehicle 100 or the like (step S210), the control device 7 judges whether or not to perform a low temperature start with reference to a low temperature mode flag 80 (step S220). In a case where the control device 7 judges that the low temperature start should be performed (the step S220; YES), the control device grasps the amount of the water remaining in the fuel cell 2 during the previous system stop, and judges whether or not the scavenging process during the previous system stop has been insufficient (step S230). In the third embodiment, it is judged whether or not the scavenging process has been insufficient, based on the estimated value of the remaining water amount obtained during the previous system stop. This respect will be described in detail. The control device 7 compares the estimated remaining water amount value We obtained during the previous system stop and stored in the estimated remaining water amount value memory 91b to the start target remaining water amount Wt stored in the start target remaining water amount memory 92b. In a case where as a result of the comparison, the estimated remaining water amount value We is the start target remaining water amount Wt or more and hence the control device (second judgment means) 7 judges that the scavenging process during the previous system stop has been insufficient (the step S230; YES), the control device executes an immediate warm-up operation (step S240). It is to be noted that another operation can be described in the same manner as in the above embodiment, and hence further description is omitted.

Thus, it may be judged by using the estimated value of the remaining water amount whether or not the scavenging process during the previous system stop has been insufficient. It is to be noted that it is judged by using a measured impedance whether or not the scavenging process during the previous system stop has been insufficient (the first embodiment), it is judged by using the scavenging time whether or not the scavenging process during the previous system stop has been insufficient (the second embodiment), it is further judged by using the estimated value of the remaining water amount whether or not the scavenging process during the previous system stop has been insufficient (the third embodiment), and it may be judged whether or not to execute an immediate warm-up operation, based on the judgment results of these three parameters (e.g., OR or AND conditions).

It is to be noted that in the above embodiments, in a case where the start command in the low temperature mode is input by the button operation of the driver or the like, it is judged that the low temperature start should be performed, but it may automatically be judged whether or not to perform the low temperature start, based on the temperature concerned with the fuel cell 2 detected by the temperature sensors 46, 47 or the outside air temperature sensor 51. This respect will be described in detail. The control device (the first judgment means) 7 compares the temperature concerned with the fuel cell 2 detected by the temperature sensors 46, 47 or the outside air temperature sensor 51 to a start judgment reference temperature (e.g., 0° C.) beforehand stored in a memory or the like. In a case where the detected temperature concerned with the fuel cell 2 is below the start judgment reference temperature, the control device 7 judges that the low temperature start should be performed, and switches the low temperature mode flag 80 from “OFF” to “ON”. Thus, it may automatically be judged whether or not to perform the low temperature start, based on the temperature concerned with the fuel cell 2 regardless of the button operation of the driver or the like.

1. A fuel cell system which performs a warm-up operation until a temperature concerned with a fuel cell reaches a reference temperature during a low temperature start, the system comprising:
a first judgment device that judges whether or not to perform the low temperature start during the start of the system;
a second judgment device that judges whether or not a scavenging process performed during the previous system stop has been insufficient;
an operation control device that continues the warm-up operation until the temperature concerned with the fuel cell reaches a target temperature higher than the reference temperature in a case where the respective judgment device judges that the low temperature start is to be performed and that the scavenging process performed during the previous system stop has been insufficient; and
a scavenging device that performs the scavenging process during the system stop.

2. The fuel cell system according to claim 1, wherein the operation control device shifts to a normal operation after the end of the warm-up operation, and
the warm-up operation is a low-efficiency operation having a large power loss as compared with the normal operation.

3. The fuel cell system according to claim 1, further comprising:
an impedance measurement device that measures the impedance of the fuel cell during the system stop,
wherein the second judgment device judges whether or not the scavenging process has been insufficient, based on the impedance of the fuel cell measured during the previous system stop.

4. The fuel cell system according to claim 1, further comprising:
a scavenging time measurement device that measures a scavenging time during the system stop,
wherein the second judgment device judges whether or not the scavenging process has been insufficient, based on the scavenging time measured during the previous system stop.

5. The fuel cell system according to claim 1, further comprising:
an estimation device that estimates the amount of water remaining in the fuel cell during the system stop,
wherein the second judgment device judges whether or not the scavenging process has been insufficient, based on the amount of the water remaining in the fuel cell estimated during the previous system stop.

6. The fuel cell system according to claim 1, wherein the temperature concerned with the fuel cell includes at least one of an outside air temperature, a component temperature around the fuel cell and a refrigerant temperature of the fuel cell, and
the first judgment device judges whether or not to perform the low temperature start, based on the temperature concerned with the fuel cell.
